(19) United States
(12) Patent Application Publication
(10) Pub. No.: US 2026/0342854 A1
(43) Pub. Date: Oct. 29, 2026

(54) SMART AUTHORIZATION TO OPERATE (ATO) ASSISTANT

(71) Applicant: Marisol Lopez Mauser, Frederick, MD (US)

(72) Inventor: Marisol Lopez Mauser, Frederick, MD (US)

(21) Appl. No.: 19/191,240

(22) Filed: Apr. 28, 2025

(51) Int. Cl. H04L 9/40

(52) U.S. Cl. CPC H04L 63/20; H04L 63/08

(57) ABSTRACT

Methods and systems performed by one or more processors and a memory in a networked computing environment, for automating and enhancing computer-implemented compliance management operations, can involve acquiring evidence data from one or more computing environments using an intelligent authorization-to-operate (ATO) assistant, the evidence data including at least one of: system logs, configuration files, access control records, and organizational policies, applying, by the intelligent ATO assistant, a machine learning model to associate the evidence data with one or more predefined compliance controls, and assessing, by the intelligent ATO assistant, a sufficiency of the evidence data in relation to the associated compliance controls to generate a compliance status output.

### TECHNICAL FIELD

Embodiments relate to computer systems and more particularly to computer systems that utilize integrated software platforms for machine learning implementations. Embodiments further relate to computer systems adapted to facilitate automated compliance. Embodiments also relate to machine learning authorization systems and methods.

### BACKGROUND

Government agencies and organizations operating in regulated environments are subject to rigorous cybersecurity and data protection standards, including those outlined in frameworks such as the Federal Risk and Authorization Management Program (FedRAMP), the Department of Defense Risk Management Framework (DoD RMF), and the National Institute of Standards and Technology (NIST) Special Publication 800-53. To operate systems within these and other environments, organizations must undergo complex compliance processes, including achieving and maintaining an Authorization-to-operate (ATO). This process typically requires substantial evidence collection, control mapping, risk assessments, and documentation, all of which must be performed accurately and consistently over time.

Conventional approaches to achieving ATO and demonstrating compliance are largely manual, document-driven, and labor-intensive. Security analysts, compliance officers, and engineers are often required to collect and review extensive audit logs, configuration files, security policies, and other artifacts to determine whether system controls meet applicable standards. These tasks not only consume considerable time and resources but are also error-prone and difficult to scale as systems evolve or grow in complexity. Furthermore, traditional compliance assessments are periodic in nature, leading to gaps in visibility and delayed identification of control failures or security risks

Efforts to automate parts of the ATO process have been limited in scope and often rely on static rule-based systems that cannot adapt to the nuanced and context-dependent nature of compliance data. These systems typically lack the flexibility to handle variations across different controls or frameworks, and they struggle to incorporate real-time telemetry or behavioral data in meaningful ways. As a result, organizations face prolonged ATO cycles, increased operational costs, and heightened risk exposure due to undetected compliance drift.

Accordingly, there is a need for improved systems and methods to automate, accelerate, and enhance compliance processes. Such systems should intelligently classify and evaluate evidence, provide continuous monitoring and adaptive control assessments, and reduce reliance on manual analysis, thereby enabling faster, more reliable authorization outcomes and ongoing assurance of compliance.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for systems and methods for automating compliance verification and authorization workflows using machine learning techniques.

It is another aspect of the embodiments to provide for intelligent compliance assistants configured to support security assessment and authorization processes under various regulatory frameworks.

It is a further aspect of the embodiments to provide for the application of machine learning models, such as a classification machine learning model, a machine learning model equipped and efficient with scoring, and a machine learning model that can detect anomalies to streamline evidence evaluation and risk assessment for compliance controls.

It is also an aspect of the embodiments to provide for a smart authorization-to-operate (ATO) assistant.

The aforementioned aspects and other objectives and advantages can now be achieved as described herein.

In an embodiment, a method, performed by at least one processor and a memory in a networked computing environment, for automating and enhancing computer-implemented compliance management operations, can be implemented, which involves: acquiring evidence data from one or more computing environments using an intelligent authorization-to-operate (ATO) assistant, the evidence data including at least one of: system logs, configuration files, access control records, and organizational policies, applying, by the intelligent ATO assistant, a machine learning model to associate the evidence data with one or more predefined compliance controls, and assessing, by the intelligent ATO assistant, a sufficiency of the evidence data in relation to the associated compliance controls to generate a compliance status output.

In an embodiment, the predefined compliance controls can correspond to controls specified in a security authorization framework.

In an embodiment, the compliance status output can include a risk score, a completeness score, or one or more alerts indicating deficiencies in the compliance posture.

In an embodiment, the intelligent ATO assistant can be configured to support ATO processes by reducing manual review of evidence and facilitating continuous compliance.

In an embodiment, the machine learning model can include one or more of: a classification model, a machine learning model that is equipped and efficient in scoring, and a machine learning model configured to detect anomalies.

An embodiment can further involve evaluating, by the intelligent ATO assistant, whether the classified evidence data satisfies the compliance requirements of corresponding security controls.

An embodiment can further involve: generating, by the intelligent ATO assistant, one or more risk or completeness scores for the evaluated evidence data based on the extent of compliance with the security controls; and identifying, by the intelligent ATO assistant, potential compliance issues or deficiencies in an ATO process based on generated risk or completeness scores; and outputting, via a user interface, a compliance status report including the classified evidence, risk assessments, and any identified compliance issues, for review by a user.

In an embodiment, a system for automating compliance management, can include one or more processors and a non-transitory computer-usable medium embodying computer program code, the computer-usable medium capable of communicating with the at least one processor, the computer program code comprising instructions executable by the one or more processors and configured for: acquiring evidence data from one or more computing environments using an intelligent authorization-to-operate (ATO) assistant, the evidence data including at least one of: system logs, configuration files, access control records, and organizational policies; applying, by the intelligent ATO assistant, a machine learning model to associate the evidence data with one or more predefined compliance controls; and assessing, by the intelligent ATO assistant, a sufficiency of the evidence data in relation to the associated compliance controls to generate a compliance status output.

In an embodiment of the system, the predefined compliance controls can correspond to controls specified in a security authorization framework.

In an embodiment of the system, the compliance status output can include, for example, a risk score, a completeness score, or one or more alerts indicating deficiencies in the compliance posture.

In an embodiment of the system, the intelligent ATO assistant can be configured to support ATO processes by reducing manual review of evidence and facilitating continuous compliance.

In an embodiment of the system, the machine learning model can include one or more of: a classification model, a machine learning model that is equipped and efficient in scoring, and a machine learning model configured to detect anomalies.

In an embodiment of the system, the instructions can be further configured for evaluating, by the intelligent ATO assistant, whether the classified evidence data satisfies the compliance requirements of corresponding security controls.

In an embodiment of the system, the instructions can be further configured for generating, by the intelligent ATO assistant, one or more risk or completeness scores for the evaluated evidence data based on the extent of compliance with the security controls, and identifying, by the intelligent ATO assistant, potential compliance issues or deficiencies in an ATO process based on generated risk or completeness scores; and outputting, via a user interface, a compliance status report including the classified evidence, risk assessments, and any identified compliance issues, for review by a user.

In an embodiment, a computer-implemented method for automating an authorization-to-operate (ATO) compliance process using a smart ATO assistant, can involve: (a) retrieving, by a machine learning model, evidence data from one or more computing systems, the evidence data comprising at least one of system logs, configuration files, access control records, or security policies; (b) classifying, by the machine learning model, the evidence data to corresponding security controls associated with one or more compliance frameworks; (c) evaluating, by the smart ATO assistant, whether the classified evidence data satisfies the compliance requirements of the corresponding security controls; (d) generating, by the smart ATO assistant, one or more risk or completeness scores for the evaluated evidence data based on the extent of compliance with the security controls; (e) identifying, by the smart ATO assistant, potential compliance issues or deficiencies in the ATO process based on the generated risk or completeness scores; and (f) outputting, via a user interface, a compliance status report including the classified evidence, risk assessments, and any identified compliance issues, for review by a user.

In an embodiment of the computer-implemented method, two or more of the steps of (a) through (e) can be performed concurrently, sequentially or intermittently.

In an embodiment of the computer-implemented method, the machine learning model can include one or more of: a classification model, a machine learning model equipped and efficient with scoring, a machine learning model configured to detect anomalies, etc.

In an embodiment of the computer-implemented method, retrieving the evidence data can involve automatically establishing authenticated API connections to remote logging servers or cloud service providers to continuously ingest evidence data in real-time.

In an embodiment of the computer-implemented method, classifying the evidence data can further involve performing feature extraction and dimensionality reduction on the evidence data to optimize input for the machine learning model and improve classification accuracy.

In an embodiment of the computer-implemented method, outputting the compliance status report further comprises generating an interactive graphical user interface (GUI) as part of the user interface, which dynamically displays risk trends, compliance gaps, and evidence traceability links based on user-selected controls or compliance frameworks.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a flow chart of operations depicting logical operational steps of a method for implementing a smart ATO assistant, in accordance with an embodiment;

FIG. 2 illustrates a flow diagram depicting steps or operations of a machine learning (ML) based ATO tool, in accordance with an embodiment;

FIG. 3 illustrates a block diagram depicting components of a system for implementing a smart ATO assistant, in accordance with an embodiment;

FIG. 4 illustrates tables depicting attributes and framework components of a smart ATO assistant, in accordance with an embodiment;

FIG. 5 illustrates example ML implementations, in accordance with various embodiments; and

FIG. 6 illustrates an example of a suitable operating environment for implementing various aspects of this disclosure and which can also include a computer, in accordance with an embodiment.

In the drawings described and illustrated herein, identical or similar parts and elements are generally indicated by identical reference numerals.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may or may not necessarily refer to the same embodiment. Similarly, phrases such as “in another embodiment” or “in another example embodiment” and variations thereof as utilized herein may or may not necessarily refer to a different embodiment. It is intended, for example, that the claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense.

Furthermore, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.”

As utilized herein, the term ‘system’ can relate to a combination of hardware, software, and/or network components that work together to perform a specific function or set of functions. A ‘system’ may include various interconnected modules, devices, processors, and interfaces that collectively achieve the desired outcome, as described in the patent claims. The system's architecture, components, and the interactions between them can operate to solve a particular problem or perform a particular task. The term ‘apparatus’ as utilized herein may be used interchangeably with the term ‘system’. The term ‘apparatus’ can also relate to a physical device or a combination of mechanical, electrical, or electronic components designed to perform a specific function or set of functions. A system may include an apparatus. Likewise, an apparatus may include a system or system(s). The terms ‘tool’ or ‘platform’ as utilized herein can also relate a system or an apparatus.

Embodiments relate generally to computer systems and, more specifically, to systems and methods for automating compliance management using machine learning techniques. Embodiments further relate to intelligent authorization-to-operate (ATO) assistants that collect, preprocess, classify, and evaluate compliance evidence artifacts to automate risk assessments and compliance status determinations.

Embodiments also relate to improvements in the field of data parsing, preprocessing, and machine learning input optimization, particularly for structured and unstructured data sources relevant to security and compliance frameworks. The disclosed systems and methods perform technical operations—such as parsing, tokenization, vectorization, classification, and risk scoring—that prepare, structure, and analyze evidence data to enable automated, real-time compliance monitoring.

In particular, embodiments integrate the authorization-to-operate (ATO) process into a practical, technological application by implementing automated computer-based solutions that transform and prepare raw evidence data for machine learning analysis, thereby facilitating continuous compliance validation without requiring extensive manual intervention.

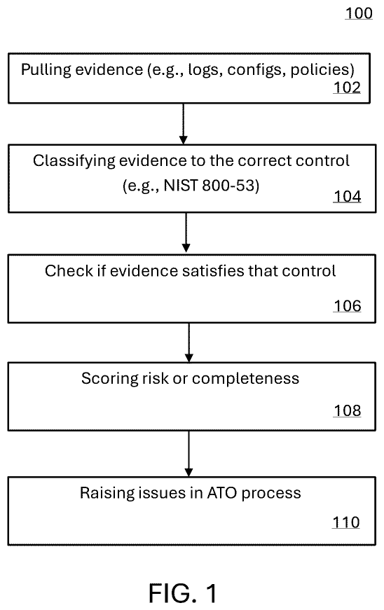

FIG. 1 illustrates a flow chart of operations depicting logical operational steps of a method 100 for implementing a smart ATO assistant, in accordance with an embodiment. Note that in FIG. 1 and the other figures illustrates and described herein, although the steps or operations of the various methods, systems, and platforms may be described in a particular order, the order of the steps or operations may be altered so that certain operations may be performed in an inverse order or so that certain steps or operations may be performed, at least in part, concurrently with other operations. In some embodiments, instructions or sub-operations of distinct steps or operations may be implemented in an intermittent manner and/or an alternating manner.

As indicated at block 102, a step or operation can be implemented to pull evidence (e.g., logs, configs, policies, etc.). Thereafter, as shown at block 104, a step or operation can be implemented to classify evidence to the correct control (e.g., NIST 800-53, etc.). Next, as depicted at block 106, a step or operation can be implemented to check or determine if the evidence satisfies that control. Then, as indicated at block 108, a step or operation can be implemented to score risk or completeness. As depicted next at block 110, a step or operation can be implemented to raise issues in the ATO process.

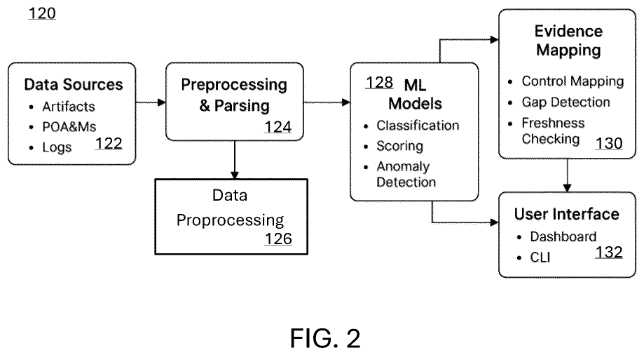

FIG. 2 illustrates a flow diagram depicting steps or operations of a machine learning (ML) based ATO tool 120, in accordance with an embodiment. Note that the term “tool” as utilized herein may also refer in some embodiments to an apparatus, a system or a platform. In the configuration shown in FIG. 2, data sources 122 can be subject to a preprocessing and parsing module 124. The data sources 122 can include, for example, artifacts, POA&Ms, and logs. A data preprocessing module 126 can also receive as input, data output from the preprocessing and parsing module 124. The data preprocessing module 126 can perform preprocessing operations involving the taking of raw data and converting it to ML language (e.g., a process of vectorization and tokenization).

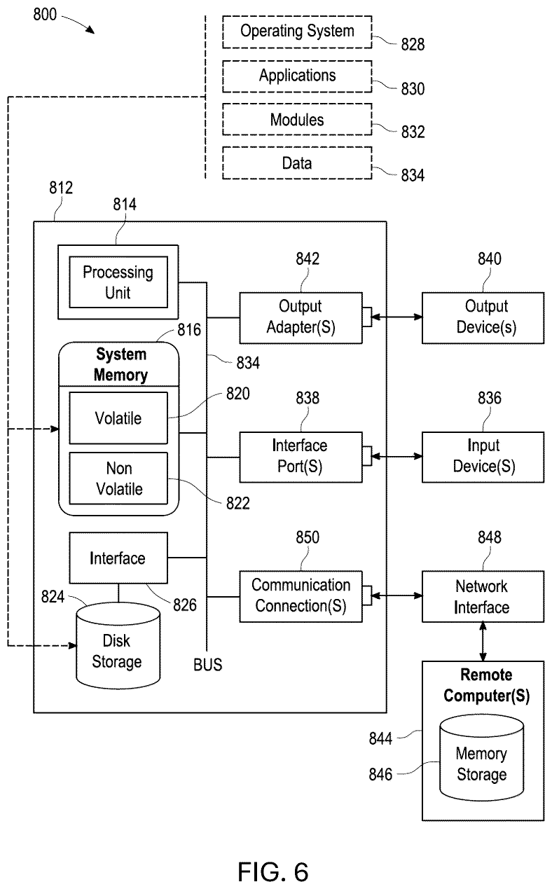

The resulting data output from the preprocessing and parsing module 124 can be then subject to the process of language formalization such as vectorization and tokenization, which allows the machine learning (ML) module 128, to understand the task requested and can be then applied and implemented by one or more different ML models (e.g., tasks such as, for example, classification, scoring, and anomaly detection). The ML module 128 can be configured to understand and extract the pertinent respective data to be able to perform tasks illustrated in evidence mapping module 130 which can then provide a form of visualization via user interface 132. Data generated from the evidence mapping module 130 and its evidence mapping operations can also be provided to the user interface 132. The evidence mapping module 130 can implement operations involving, for example, control mapping, gap detection, and freshness checking. The user interface 132 may be implemented as, for example, a dashboard or CLI. An example of the user interface 132 is the interface 826 described herein with respect to FIG. 6.

Note that as utilized herein, the term “machine learning” or ML can relate to a machine learning model, which is a data-driven computational construct generated through a training process, wherein the model learns patterns, features, or statistical relationships from a dataset to perform tasks such as classification, regression, clustering, prediction, or decision-making. The ML model may include a set of parameters, algorithms, or mathematical functions configured to receive input data and produce corresponding outputs based on the learned patterns.

A classification model is a type of machine learning model that categorizes input data into one of a predefined set of discrete classes or labels. During training, the model learns from labeled datasets, where each input is associated with a known class, enabling the model to predict the most probable class for new, unseen data. In the context of compliance automation, a classification model may be used to automatically assign evidence data (e.g., logs, configurations, or policy documents) to corresponding compliance control categories or regulatory domains.

Various ML models that are equipped and efficient in scoring can be configured to generate numerical or ordinal value (i.e., a “score”) representing the degree to which an input satisfies a particular criterion, likelihood, or risk factor. These models are commonly used in risk assessment, prioritization, and compliance completeness analysis. For example, in a security compliance system, models used for scoring may evaluate how well a set of control evidence meets the requirements of a given compliance control and output a confidence score or risk level associated with that evaluation.

Various ML models can also be configured to detect anomalies which are designed to identify data points, patterns, or events that deviate significantly from an expected norm or baseline. These models are typically trained on data representing normal behavior and are used to detect unusual or potentially problematic conditions. In a compliance context, models used for anomaly detection may monitor system configurations, access logs, or user behavior to flag activities or evidence that appear inconsistent with compliant or authorized operations, thereby supporting early detection of security or compliance breaches.

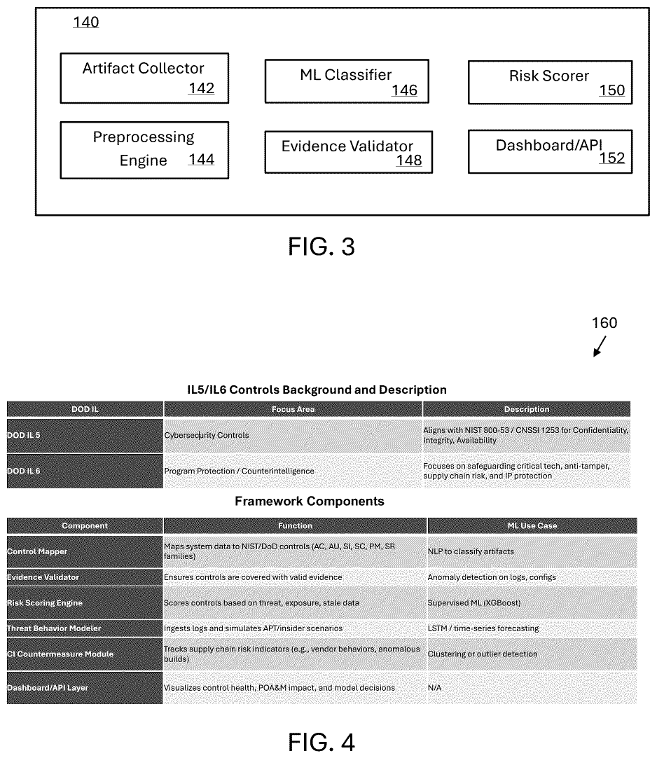

FIG. 3 illustrates a block diagram depicting components of a system 140 for implementing a smart ATO assistant, in accordance with an embodiment. The system 140 shown in FIG. 3 can include an artifact collector 142, an ML classifier 146, a risk scorer 150, a preprocessing engine 144, an evidence evaluator 148, and a dashboard/API 152. The dashboard/API 152 can implement, for example, the user interface 132 discussed above with respect to FIG. 2. The artifact collector 142 can collect artifacts, which are examples of data sources 122 discussed above with respect to FIG. 2. The preprocessing engine 144 can implement the preprocessing and parsing module 124 or may implement aspects of the preprocessing and parsing module 124. The evidence evaluator 148 can be used to implement the evidence mapping module 130 or aspects of the evidence mapping module 130 shown in FIG. 2. The risk scorer 150 can be used to implement the scoring aspect of the ML module 128 shown in FIG. 2.

The artifact collector 142 is responsible for acquiring and aggregating artifacts from a variety of systems and cloud-based data sources, including, but not limited to, audit logs, configuration files, policy documents, user access records, incident response reports, vulnerability scans, and third-party service attestations. These artifacts may be pulled in real-time, on a scheduled basis, or triggered by events or changes in the monitored environment. In some embodiments, the artifact collector 142 may connect to APIs, log streams, file repositories, or compliance management platforms to obtain data. The collector can be capable of handling multiple data formats, such as JSON, XML, CSV, or unstructured text, and may also support integration with services like AWS CloudTrail, Azure Security Center, or Kubernetes audit logs. The artifact collector 142 can ensure that the relevant evidence is systematically retrieved, normalized by metadata (e.g., timestamps, source system, user ID), and queued for processing.

The preprocessing engine 144 can work in coordination with the artifact collector 142 to transform raw artifacts into structured and enriched input suitable for machine learning models and compliance mapping functions. In various embodiments, the preprocessing engine 144 performs tasks such as data normalization, log parsing, identity resolution, temporal correlation, deduplication, noise filtering, and frequency or statistical aggregation. For example, when processing access logs, the engine may extract fields such as user identity, IP address, access time, and resource accessed, and convert them into consistent formats with standardized field names and timestamp granularity.

Additionally, the preprocessing engine 144 may apply feature extraction techniques relevant to a given control or framework. These features may include behavioral indicators (e.g., frequency of failed login attempts), usage patterns (e.g., access to restricted data after hours), or configuration drifts (e.g., changes in security group settings). The processed output can be then structured as input features for subsequent components, including the ML classifier 146, evidence evaluator 148, and risk scorer 150.

By modularizing the artifact collection and preprocessing functionality, system 140 can enable consistent, scalable, and framework-agnostic compliance data preparation, ensuring that machine learning models are supplied with clean, meaningful, and contextually relevant input across a wide variety of security controls and authorization frameworks.

As utilized herein the term “smart” refers to the capability of the ATO assistant to perform context-aware, adaptive, and automated decision-making functions by leveraging artificial intelligence (AI) and machine learning (ML) technologies. A smart ATO assistant is not limited to rule-based logic; rather, it dynamically learns from historical compliance data, system behaviors, and risk patterns to improve its assessments over time.

In various embodiments, “smart” functionality may include the automated classification of control evidence, predictive risk scoring, anomaly detection, and the ability to recommend or extract (and/or in some cases, generate) compliance artifacts. The smart ATO assistant may further incorporate feedback loops, confidence thresholds, and continuous learning mechanisms to refine its performance and adapt to evolving compliance standards, environments, and system architectures. This intelligent behavior significantly reduces the need for manual intervention, enabling real-time or near-real-time compliance support across diverse regulatory frameworks.

It can be appreciated that the various modules and operations described herein, such as, for example the preprocessing engine 144, the ML classifier 146, the artifact collector 142, the data preprocessing module 126, and so on, enhance the technological operation of the disclosed smart ATO assistant by performing specific, technical transformations on raw data received from computing environments. For example, the preprocessing operations involve converting unstructured or semi-structured evidence data (such as system logs, configuration files, or access control records) into a structured machine learning (ML) input format using vectorization and tokenization techniques.

These operations are rooted in computer science and involve manipulating data at a low level to enable further automated processing by machine learning algorithms. Vectorization refers to transforming textual or categorical data into numerical vectors that can be mathematically processed by ML models. Tokenization involves parsing input data streams into discrete elements (tokens), facilitating structured analysis and pattern recognition. These transformations are not mental steps or generic human activities but are operations uniquely suited for computer execution at scale and speed, particularly when dealing with high-volume or real-time evidence streams.

By converting raw, disparate evidence artifacts into optimized numerical or structured representations, the preprocessing module significantly improves the ability of the ML model to classify, evaluate, and assess compliance-related information efficiently and accurately. This technical improvement is fundamental to the smart ATO assistant's ability to automate compliance assessments-a process that would otherwise require extensive manual effort prone to errors and inconsistencies.

Moreover, the preprocessing operations can form an indispensable part of an integrated, end-to-end technological solution that transforms and enhances the underlying data to make it machine-readable and actionable. Without such preprocessing operations along with other operations, the subsequent machine learning classification and risk scoring steps would be technically infeasible or substantially degraded in performance. As such, the data preprocessing operations provide a meaningful improvement to the functioning of the compliance system and the computer system itself, not merely using a computer as a tool for human activity.

Thus, the preprocessing module can apply specific technical solutions to address data preparation challenges in ML-driven compliance workflows, integrating any abstract ideas into a broader, practical, and technological application that improves overall system functionality.

In addition to vectorization and tokenization, the disclosed parsing operations performed by the data preprocessing module further contribute to the practical application of the system. Parsing transforms unstructured or loosely structured input artifacts, such as event logs or configuration files, into logically organized data elements that can be systematically analyzed by the machine learning models. This enables the smart ATO assistant to extract critical compliance-relevant information-such as user identities, access timestamps, configuration settings, and policy rules—from otherwise disorganized or voluminous raw data sources.

By implementing parsing in a manner specifically tailored for compliance evidence, the preprocessing module ensures that downstream machine learning components receive clean, structured inputs that are semantically meaningful within the compliance context. This targeted preparation of data not only improves model performance and system reliability but also enables automated compliance assessment operations that would otherwise require manual review by human experts. Consequently, the parsing operations provide a concrete technological improvement by transforming raw artifacts into structured datasets that are actionable by automated systems, thereby integrating the described features into a real-world, technological workflow.

FIG. 4 illustrates table 160 depicting attributes and framework components of a smart ATO assistant, in accordance with an embodiment. The tables 160 shown in FIG. 4 can include, for example, a focus involving cybersecurity controls and program protection/counterintelligence (with respect to for example DOD IL) and so on. The tables 160 also refer to components such as a control mapper, evidence validator, risk scoring engine, threat behavior modeler, countermeasure module, and dashboard/AIP layer.

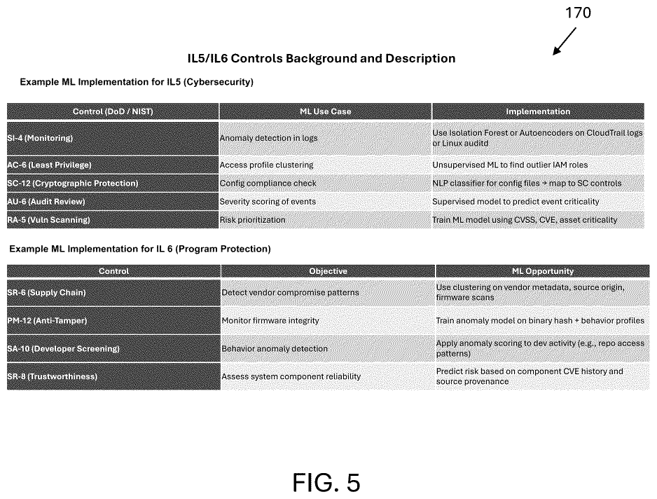

FIG. 5 illustrates example ML implementations 170, in accordance with various embodiments. In the tables shown in FIG. 5, example controls for cybersecurity implementation can include but are not limited to SI-4 (monitoring), AC-6 (least privilege), SC-12 (cryptographic protection), AU-6 (audit review), and RA-5 (vuln scanning). Example ML use cases include, for example, anomaly detection in logs, access profile clustering, config compliance check, severity scoring of events, and risk prioritization. Implementations can include, for example, the use Isolation Forest or Autoencoders on CloudTrail logs or Linux audit logs, unsupervised ML to find outliers in IAM roles, NLP classier for config files to map to SC controls, supervised model to predict event criticality, training ML models using CVSS, CVE and asset criticality and so on.

Note that in FIG. 4 and FIG. 5, the information contained in the various illustrated tables are exemplary only and are not limited features of the embodiments. The embodiments can be implemented in applications beyond, for example, DOD IL, SI-4, AC-6 and so on.

In some embodiments, a reusable and modular format for constructing custom machine learning models can be configured and tailored to individual compliance controls, such as those found in the NIST 800-53 framework. For instance, a model may be developed for Control SI-4, titled “System Monitoring,” which belongs to the System and Information Integrity (SI) control family.

For this particular control, the embodiments can implement an anomaly detection task using the Isolation Forest algorithm. The model can be designed to process AWS CloudTrail logs, which are formatted in JSON. Before model training, the input data undergoes several preprocessing operations. These operations include normalizing timestamps to ensure consistent temporal formatting across log entries, parsing user identity fields to extract relevant user-related metadata, and aggregating event frequency based on source IP address to capture behavioral trends that may indicate anomalous system activity.

Once trained, the model can produce an output that includes a label indicating whether the log entry is classified as either “Normal” or “Suspicious,” along with a numerical anomaly score ranging from 0.0 to 1.0. This score represents the model's assessment of how significantly a given event deviates from baseline behavior. The performance of the model can be evaluated using commonly accepted metrics in machine learning, including accuracy, precision, recall, F1-Score and the area under the curve (AUC).

The resulting model can be then integrated into a target environment, such as a dashboard widget for continuous monitoring or an automated alerting pipeline. This integration enables real-time or near-real-time feedback to security and compliance teams, facilitating continuous control validation and timely identification of potential risks or system integrity violations. This approach may be applied across multiple controls by leveraging the reusable format, allowing organizations to construct and deploy intelligent, control-specific models that streamline compliance efforts and reduce manual review overhead.

Below is a description of a step-by-step guide to building an ML-based ATO tool. It should be appreciated that the description below may vary depending on design goals. The first step in building the ML-based ATO tool can involve defining the scope of the ML-based ATO tool.

### Step 1: Define the Scope of the Tool

Goal: Automate evidence generation, classification, and mapping for selected NIST controls (e.g., SI-4, AC-6, SC-12).

TABLE 1

| Feature | Description |
|---|---|
| Artifact Tagging | Automatically classify artifacts |
| | (e.g., logs, configs) by control family |
| Control Gap | Use ML to flag likely missing or inconsistent |
| Detection | controls |
| POA&M Scoring | Predict risk and resolution complexity |
| Evidence Freshness | Use timestamp analysis to validate periodicity |
| Monitor | (e.g., monthly scans) |

### Step 2: Collect Data and Build Training Sets

Use internal datasets or simulated samples:

TABLE 2

| Artifact Type | Label/Mapping |
|---|---|
| Audit logs | AU-2, AU-6, SI-4 |
| AWS Config | CM-6, CM-2 |
| Snapshots | |
| POA&M Exports | Risk scores (High, Medium, Low) |
| Control Narratives | CA-2, PL-2 |

Annotate or tag them with:
Control ID
Control status (sufficient/missing/outdated)
Artifact source
Evidence type (script output, log, config, scan result)

### Step 3: Build the ML Pipeline

TABLE 3

| Task | ML Model |
|---|---|
| Text → Control ID | BERT, spaCy, Tfidf + XGBoost |
| Classification | |
| Artifact Validity | Anomaly Detection (Isolation Forest, |
| | OneClassSVM) |
| POA&M Risk Scoring | RandomForest, XGBoost |
| Evidence Date Freshness | Time-series, heuristics, |
| | anomaly detection |

### Example: Applying the Classification Model to NIST Control (SC-12, IA-2)

from sklearn.feature_extraction.text import TfidfVectorizer
from sklearn.linear_model import LogisticRegression
X_text=[“s3-bucket-encryption enabled”, “IAM role MFA not enforced”]
y_labels=[“SC-12”, “IA-2”]
vectorizer=TfidfVectorizer( )
X=vectorizer.fit_transform(X_text)
clf=LogisticRegression( ).fit(X, y_labels)
clf.predict (vectorizer.transform ([“bucket policy has deny public access”]))
#Output: [“SC-12”]

### Step 4: Build Evidence Mapping Engine

This engine maps predicted artifacts to:
Control ID
Control Status (compliant/non-compliant/needs review)
Control Frequency (monthly, yearly, ongoing)

Use a JSON template for validation:
json

```
{
  ″control″: ″SC-12″,
  ″status″: ″sufficient″,
  ″artifact_type″: ″config″,
  ″source″: ″AWS CLI″,
  ″last_validated″: ″2025-04-01″
}
```

### Step 5: Expose It Through a Web UI or CLI

### Build a Minimal Dashboard or CLI:

Upload evidence
View mapping to controls
Highlight gaps.
Score POA&M items

### Potential Tools:

Streamlit or Dash (for quick UI)
FastAPI+React (for production-grade interface).
Store in PostgreSQL, MongoDB, or flat JSON store for PoC

### Step 6: Optional Enhancements

TABLE 4

| Feature | Purpose |
|---|---|
| Explainable ML | Show why artifact was mapped to a |
| (XAI) | specific control |
| Model Feedback | Accept user input to fine-tune |
| Loop | classifications |
| ChatGPT Plugin | Turn this into a conversational ATO assistant |
| ConMon | Connect to Splunk, AWS Config, Prisma |
| Integrations | Cloud for live evidence polling |

Note that each of the illustrated components or blocks such as, for example, the artifact collector 142, preprocessing engine 144, ML classifier 146, evidence validator 148, risk scorer 150, Dashboard/API 142, and so on, may be implemented as modules. Although not required, the disclosed embodiments can be described in the general context of computer-executable instructions, such as program modules, being executed by a single computer or a group of computers. In most instances, such a “module” or component may constitute a software application but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be typically private (accessible only to that module) and which includes source code that actually implements the routines in the module. The term module may also simply refer to an application, such as a computer program designed to assist in the performance of a specific task, such as artifact collection, preprocessing, ML classification, etc.

In some example embodiments, the term “module” can also refer to a modular hardware component or a component that is a combination of hardware and software. It should be appreciated that implementation and processing of such modules or components according to the approach described herein can lead to improvements in processing speed and in energy savings and efficiencies in a data-processing system such as, for example, the system 140 described previously and/or the operating environment 800 discussed below with respect to FIG. 6. The various components when integrated as disclosed herein may lead to improvements in data retrieval speed and a reduction in latency. The system 140 may comprise, for example, a preprocessing engine 140, which may employ in some embodiments, a caching mechanism to improve data retrieval speed and reduce latency during high-demand periods.

In the above description, specific details of various embodiments are provided. However, some embodiments may be practiced with less than all of these specific details. In other instances, certain methods, procedures, components, structures, and/or functions are described in no more detail than to enable the various embodiments, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer usable storage medium for execution by a computer. As an example, an embodiment of a computer program product includes a computer usable storage medium to store a computer readable program.

FIG. 6 illustrates an example of a suitable operating environment 800 for implementing various aspects of this disclosure and which can also include a computer 812, in accordance with an embodiment. The computer 812 can also include a processing unit 814, a system memory 816, and a system bus 834. The system bus 834 couples system components including, but not limited to, the system memory 816 to the processing unit 814. The processing unit 814 can be any of various available processors. Dual microprocessors and other multiprocessor architectures also can be employed as the processing unit 814.

The system bus 834 can be any of several types of bus structure(s) including, for example, a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1094), and Small Computer Systems Interface (SCSI). The system memory 816 can also include volatile memory 820 and nonvolatile memory 822. The basic input/output system (BIOS), containing the basic routines to transfer information between elements within the computer 812, such as during start-up, can be stored in nonvolatile memory 822.

By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM). Volatile memory 820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 can also include removable/non-removable, volatile/non-volatile computer storage media. FIG. 6 illustrates, for example, a disk storage 824. Disk storage 824 can also include, but is not limited to, devices like a magnetic disk drive, floppy disk drive, tape drive, Jaz drive, Zip drive, LS-100 drive, flash memory card, memory stick and so on. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 824 to the system bus 834, a removable or non-removable interface is typically used, such as interface 826.

FIG. 6 also depicts software that can act as an intermediary between users and the basic computer resources described in the suitable operating environment 800. Such software can also include, for example, an operating system 828. Operating system 828, which can be stored on disk storage 824, acts to control and allocate resources of the computer 812. System applications 830 can take advantage of the management of resources by operating system 828 through program modules 832 and program data 834, e.g., stored either in system memory 816 or on disk storage 824. It is to be appreciated that this disclosure can be implemented with various operating systems or combinations of operating systems.

A user can enter commands or information into the computer 812 through input device(s) 836. Input device(s) 836 include, but are not limited to, a pointing device such as a mouse, trackball, stylus, touch pad, keyboard, microphone, joystick, gamepad, satellite dish, scanner, TV tuner card, digital camera, digital video camera, web camera, and the like. These and other input devices can connect to the processing unit 814 through the system bus 834 via interface port(s) 838. Interface port(s) 838 can include, for example, a serial port, a parallel port, a game port, and a universal serial bus (USB). Output device(s) 840 may use some of the same type of ports as input device(s) 836.

Thus, for example, a USB port can be used to provide input to computer 812, and to output information from computer 812 to an output device 840. Output adapter 842 is provided herein to illustrate that there may be some output devices 840 like monitors, speakers, and printers, among other output devices 840, which require special adapters. The output adapters 842 include, by way of illustration and not limitation, video and sound cards that provide a means of connection between the output device 840 and the system bus 834. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor-based appliance, a peer device or other common network node and the like and can also include many or all the elements described relative to computer 812. For purposes of brevity, only a memory storage device 846 is illustrated with remote computer(s) 844. Remote computer(s) 844 can be logically connected to computer 812 through a network interface 848 and then can be physically connected via communication connection 850.

Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to, for example, the system bus 834. While communication connection 850 is shown for illustrative clarity inside computer 812, it can also be external to the computer 812. The hardware/software for connection to the network interface 848 can also include, for exemplary purposes only, internal and external technologies such as, modems including regular telephone grade modems, cable modems and DSL modems, ISDN adapters, and Ethernet cards.

Embodiments may be implemented in or as a system, a method, an apparatus and/or a computer program product at any possible technical detail level of integration. The computer program product can include a computer readable storage medium (or media) having computer readable program instructions thereon for causing a processor to carry out aspects of the embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium can also include the following: a portable computer diskette, a hard disk, a random access memory (RAM), a read-only memory (ROM), an erasable programmable read-only memory (EEPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in one or more computing/processing device receives computer readable program instructions from the network and forwards the computer readable program instructions for storage in a computer readable storage medium within the respective computing/processing device.

Computer readable program instructions for carrying out operations of various aspects of the embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as, for example, Python, Smalltalk, C++, or the like, and procedural programming languages, such as the “C” programming language or similar programming languages. It should be appreciated that reference herein to such specific programming languages is for exemplary and illustrative purposes only and are not limiting features of the embodiments.

The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, to perform aspects of the embodiments.

Aspects of the embodiments are described herein with reference to flowchart illustrations and/or block diagrams of methods, apparatus (systems), and computer program products according to embodiments of the invention. It can be understood that one or more blocks of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions can also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the embodiments. In this regard, one or more blocks in the flowchart or block diagrams can represent a module, segment, or portion of instructions, which comprises one or more executable instructions for implementing the specified logical function(s).

In some alternative implementations of the embodiments, the functions noted in the blocks can occur out of the order noted in the figures. For example, two blocks shown in succession can, in fact, be executed substantially concurrently, or the blocks can sometimes be executed in the reverse order, depending upon the functionality involved. It can also be noted that one or more block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art can recognize that this disclosure also can or can be implemented in combination with other program modules. Generally, program modules include routines, programs, components, data structures, etc. that perform particular tasks and/or implement abstract data types. Moreover, those skilled in the art can appreciate that the inventive computer-implemented methods can be practiced with other computer system configurations, including single-processor or multiprocessor computer systems, mini-computing devices, mainframe computers, as well as computers, hand-held computing devices (e.g., PDA, cellular phone, etc.), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” “module,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer.

By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multi thread execution capability; multi-core processors; multi-core processors with software multi thread execution capability; multi-core processors with hardware multithread technology; parallel platforms; and parallel platforms with distributed shared memory. Additionally, the term “processor” can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein.

Further, processors can exploit nano-scale architectures such as, but not limited to, molecular and quantum-dot based transistors, switches and gates, to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products, and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible.

Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration but are not intended to be exhaustive or limited to the embodiments disclosed.

Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A computer-implemented method, performed by at least one processor and a memory in a networked computing environment, for automating and enhancing computer-implemented compliance management operations, the method comprising:
acquiring evidence data from one or more computing environments using an intelligent authorization-to-operate (ATO) assistant, the evidence data including at least one of: system logs, configuration files, access control records, and organizational policies;
applying, by the intelligent ATO assistant, a machine learning model to associate the evidence data with one or more predefined compliance controls; and
assessing, by the intelligent ATO assistant, a sufficiency of the evidence data in relation to the associated compliance controls to generate a compliance status output.

2. The computer-implemented method of claim 1, wherein the predefined compliance controls correspond to controls specified in a security authorization framework.

3. The computer-implemented method of claim 1, wherein the compliance status output includes a risk score, a completeness score, or one or more alerts indicating deficiencies in the compliance posture.

4. The computer-implemented method of claim 1, wherein the intelligent ATO assistant is configured to support ATO processes by reducing manual review of evidence and facilitating continuous compliance.

5. The computer-implemented method of claim 1, wherein the machine learning model comprises at least one of: a classification model, a machine learning model that is equipped and efficient in scoring, and a machine learning model configured to detect anomalies.

6. The computer-implemented method of claim 1, further comprising evaluating, by the intelligent ATO assistant, whether the classified evidence data satisfies the compliance requirements of corresponding security controls.

7. The computer-implemented method of claim 1, further comprising:
generating, by the intelligent ATO assistant, one or more risk or completeness scores for the evaluated evidence data based on the extent of compliance with the security controls;
identifying, by the intelligent ATO assistant, potential compliance issues or deficiencies in an ATO process based on generated risk or completeness scores; and outputting, via a user interface, a compliance status report including the classified evidence, risk assessments, and any identified compliance issues, for review by a user.

8. A system for automating compliance management, comprising:
at least one processor; and
a non-transitory computer-usable medium embodying computer program code, the computer-usable medium capable of communicating with the at least one processor, the computer program code comprising instructions executable by the at least one processor and configured for:
acquiring evidence data from one or more computing environments using an intelligent authorization-to-operate (ATO) assistant, the evidence data including at least one of: system logs, configuration files, access control records, and organizational policies;
applying, by the intelligent ATO assistant, a machine learning model to associate the evidence data with one or more predefined compliance controls; and
assessing, by the intelligent ATO assistant, a sufficiency of the evidence data in relation to the associated compliance controls to generate a compliance status output.

9. The system of claim 1, wherein the predefined compliance controls correspond to controls specified in a security authorization framework.

10. The system of claim 8, wherein the compliance status output includes a risk score, a completeness score, or one or more alerts indicating deficiencies in the compliance posture.

11. The system of claim 8, wherein the intelligent ATO assistant is configured to support ATO processes by reducing manual review of evidence and facilitating continuous compliance.

12. The system of claim 8, wherein the machine learning model comprises at least one of: a classification model, a machine learning model that is equipped and efficient in scoring, and a machine learning model configured to detect anomalies.

13. The system of claim 8, wherein the instructions are further configured for evaluating, by the intelligent ATO assistant, whether the classified evidence data satisfies the compliance requirements of corresponding security controls.

14. The system of claim 8, wherein the instructions are further configured for:
generating, by the intelligent ATO assistant, one or more risk or completeness scores for the evaluated evidence data based on the extent of compliance with the security controls;
identifying, by the intelligent ATO assistant, potential compliance issues or deficiencies in an ATO process based on generated risk or completeness scores; and outputting, via a user interface, a compliance status report including the classified evidence, risk assessments, and any identified compliance issues, for review by a user.

15. A computer-implemented method for automating an authorization-to-operate (ATO) compliance process using a smart ATO assistant, the method comprising:
(a) retrieving, by a machine learning model, evidence data from one or more computing systems, the evidence data comprising at least one of system logs, configuration files, access control records, or security policies;
(b) classifying, by the machine learning model, the evidence data to corresponding security controls associated with one or more compliance frameworks;
(c) evaluating, by the smart ATO assistant, whether the classified evidence data satisfies the compliance requirements of the corresponding security controls;
(d) generating, by the smart ATO assistant, one or more risk or completeness scores for the evaluated evidence data based on the extent of compliance with the security controls;
(e) identifying, by the smart ATO assistant, potential compliance issues or deficiencies in the ATO process based on the generated risk or completeness scores; and
(f) outputting, via a user interface, a compliance status report including the classified evidence, risk assessments, and any identified compliance issues, for review by a user.

16. The computer-implemented method of claim 15 wherein at least two of steps (a) through (e) are performed concurrently, sequentially or intermittently.

17. The computer-implemented method of claim 15 wherein the machine learning model comprises at least one of: a classification model, a machine learning model equipped and efficient with scoring, and a machine learning model configured to detect anomalies.

18. The computer-implemented method of claim 15, wherein retrieving the evidence data comprises automatically establishing authenticated API connections to remote logging servers or cloud service providers to continuously ingest evidence data in real-time.

19. The computer-implemented method of claim 15, wherein classifying the evidence data further comprises performing feature extraction and dimensionality reduction on the evidence data to optimize input for the machine learning model and improve classification accuracy.

20. The computer-implemented method of claim 15, wherein outputting the compliance status report further comprises generating an interactive graphical user interface (GUI) as part of the user interface, which dynamically displays risk trends, compliance gaps, and evidence traceability links based on user-selected controls or compliance frameworks.
